(19) United States
(12) Patent Application Publication
(10) Pub. No.: US 2019/0178577 A1
(43) Pub. Date: Jun. 13, 2019

(54) Deslagging Device of Vacuum Inert Gas Atomization System

(71) Applicant: CHIA YI STEEL CO., LTD., Chiayi Hsien (TW)

(72) Inventors: Chien-Hung Yeh, Chiayi Hsien (TW); Cheng-Chin Wang, Chiayi Hsien (TW); Chih-Ming Lin, Chiayi Hsien (TW); Yu-Chiao Yang, Chiayi Hsien (TW)

(21) Appl. No.: 15/838,436

(22) Filed: Dec. 12, 2017

(51) Int. Cl. F27D 3/15; F25J 3/08

(52) U.S. Cl. CPC F27D 3/1554; F23J 1/06; F25J 3/08

(57) ABSTRACT

A deslagging device has an assembling rod and a deslagging plate. The assembling rod has a mounting head and an assembling section connected to the mounting head. The deslagging plate is mounted to the assembling rod and has a plate mounted to the assembling section and having a first face, a second face, and multiple conical channels. The first face and the second face face to opposite directions. The first face faces to the mounting head. The multiple conical channels are defined through the plate and spaced apart from one another. Each one of the multiple conical channels has a first opening and a second opening. The first opening is formed in the first face of the plate and has a diameter. The second opening is formed in the second face of the plate and has a diameter larger than the diameter of the first opening.

### BACKGROUND OF THE INVENTION

### 1. Field of the Invention

The present invention relates to an atomization apparatus, and more particularly to a deslagging device of a vacuum inert gas atomization system that is able to remove slag floating on liquid metal.

### 2. Description of Related Art

With progress of modern science and technology, requirement for quality of metal or alloy is more and more strict. The high quality requirement of metal or alloy promotes rapid progress of technology of atomization and makes superalloy made by atomization extensively applied. The superalloy such as Nickel-based superalloy is wildly applied to fields of aircraft, biochemistry, petrochemical industry, and biomedical industry. Solid metal is melted, atomized, and solidified during the atomization process and then transformed into metal powder. Alloying degree and purity of the metal powder made by atomization are improved, satisfying requirements of the abovementioned fields. Take vacuum inert gas atomization, abbreviated as VIGA, for example. A conventional apparatus of VIGA has a vacuum chamber, a heater, and a nozzle. Metal is received in the vacuum chamber and heated by the heater to transform to liquid metal. The liquid metal is compressed, then ejected from the nozzle, and eventually transformed into ball-shaped powders that are suitable for 3D printing.

However, there is often a slag layer floating above the liquid metal. In order to prevent the liquid metal from being oxidized or reacting with other compositions in the air, the vacuum chamber cannot be opened to proceed deslagging. Therefore, the slag layer floating above the liquid metal causes defective quality of the metal powders.

To overcome the shortcomings of the conventional apparatus of VIGA, the present invention provides a deslagging device of a vacuum inert gas atomization system to mitigate or obviate the aforementioned problems.

### SUMMARY OF THE INVENTION

The main objective of the present invention is to provide a deslagging device of a vacuum inert gas atomization system that is able to remove slag floating on liquid metal to promote quality of metal powders produced by the vacuum inert gas atomization system.

The deslagging device comprises an assembling rod and a deslagging plate. The assembling rod has a mounting head and an assembling section connected to the mounting head. The deslagging plate is mounted to the assembling rod and has a plate mounted to the assembling section and having a first face, a second face, and multiple conical channels. The first face and the second face face to opposite directions. The first face faces to the mounting head. The multiple conical channels are defined through the plate and spaced apart from one another. Each one of the multiple conical channels has a first opening and a second opening. The first opening is formed in the first face of the plate and has a diameter. The second opening is formed in the second face of the plate and has a diameter larger than the diameter of the first opening.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a deslagging device of a vacuum inert gas atomization system in accordance with the present invention;

FIG. 2 is another perspective view of the deslagging device in FIG. 1;

FIG. 3 is a cross sectional side view of the deslagging device in FIG. 1;

FIG. 4 is a schematic side view in partial section of the deslagging device in FIG. 1;

FIG. 5 is an operational schematic side view in partial section of the deslagging device in FIG. 1;

FIG. 6 is another operational schematic side view in partial section of the deslagging device in FIG. 1; and

FIG. 7 is still another operational schematic side view in partial section of the deslagging device in FIG. 1.

### DETAILED DESCRIPTION OF PREFERRED EMBODIMENTS

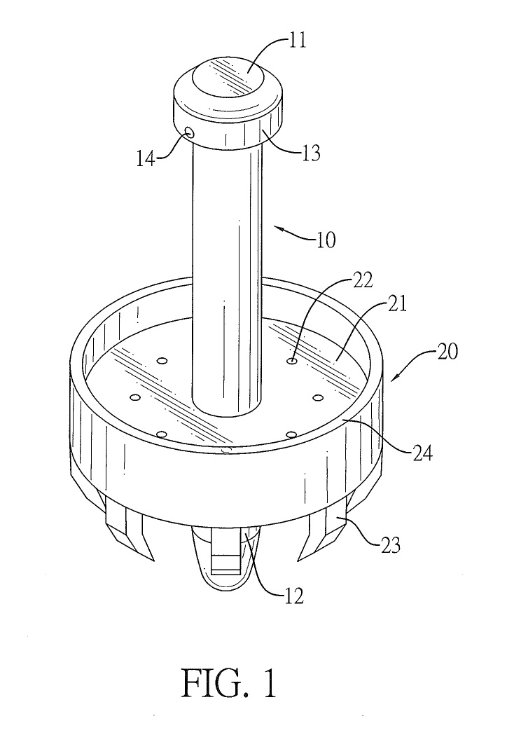

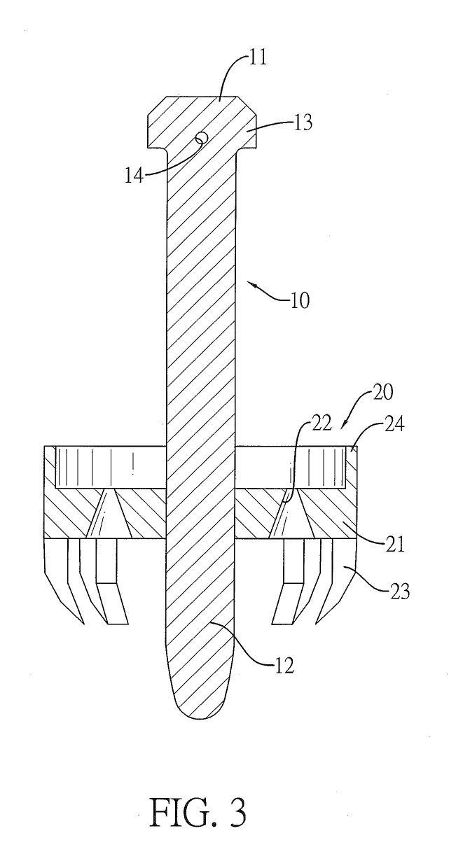

With reference to FIGS. 1, 2, and 3, a deslagging device in accordance with the present invention has an assembling rod 10 and a deslagging plate 20 mounted to the assembling rod 10.

The assembling rod 10 has a munting head 11 and an assembling section 12. The mounting head 11 has a mounting flange 13 and a connecting hole 14. The connecting hole 14 is defined through the mounting flange 13 along a radial direction of the mounting flange 13. The assembling section 12 is connected to the mounting head 10 and extends along a direction that is perpendicular to the radial direction of the mounting flange 13.

The deslagging plate 20 has a plate 21, multiple conical channels 22, multiple stirring units 23, and a blocking wall 24. The plate 21 is a round disk, is mounted to the assembling section 12, and has a first face, a second face, and a rim. The first face and the second face of the plate 21 face to opposite directions. The first face of the plate 21 faces to the mounting head 11.

The multiple conical channels 22 are defined through the plate 21, are spaced apart from one another, and are circularly disposed around the assembling section 12. Each one of the multiple conical channels 22 has a first opening and a second opening. The first opening is defined in the first face of the plate 21 and has a diameter. The second opening is defined in the second face of the plate 21 and has a diameter larger than the diameter of the first opening.

The multiple stirring units 23 are formed on the second face of the plate 21, disposed along the rim of the plate 21, and circularly disposed around the assembling section 12. Each one of the multiple stirring units 23 is shaped as a claw.

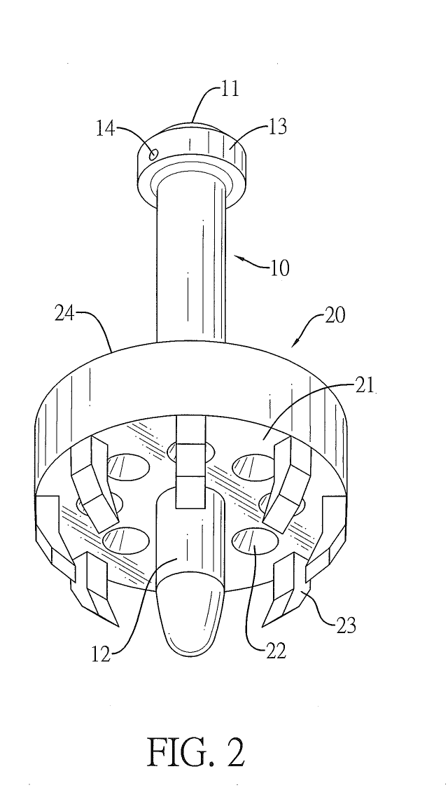

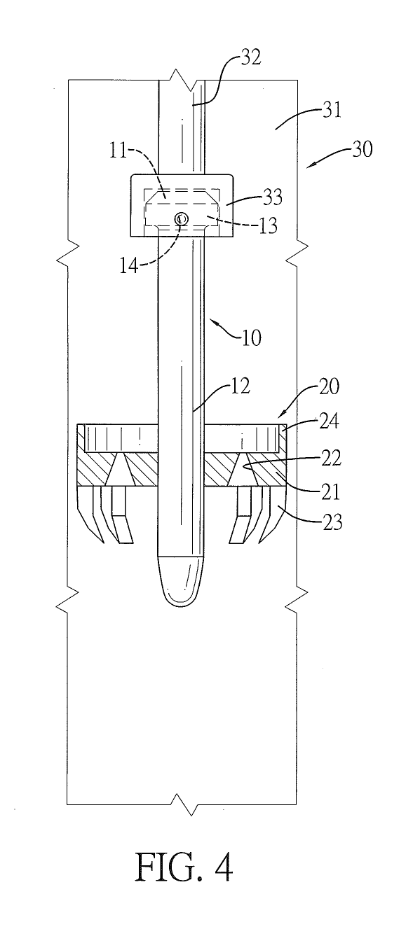

With reference to FIGS. 2 to 5, the assembling rod 10 is mounted to a grabbing device 30. The grabbing device 30 is connected to a vacuum inert gas atomization (VIGA) apparatus 40 and communicates with the VIGA apparatus 40. The grabbing device 30 has a shell 31, an elevatable component 32, and a spinning component 33. The elevatable component 32 and the spinning component 33 are disposed in the shell 31. The spinning component 33 is connected to the elevatable component 32 and is able to rotate relative to the elevatable component 32. The mounting flange 13 of the mounting head 11 of the assembling rod 10 is mounted to the spinning component 33 and is able to rotate with the spinning component 33.

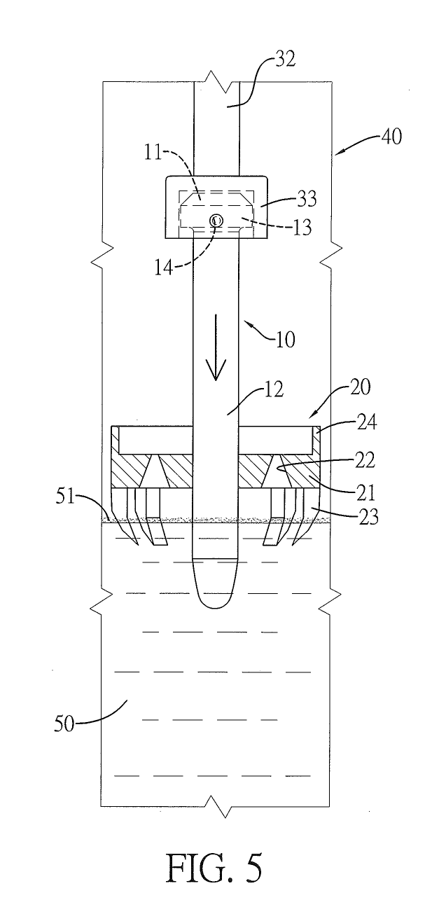

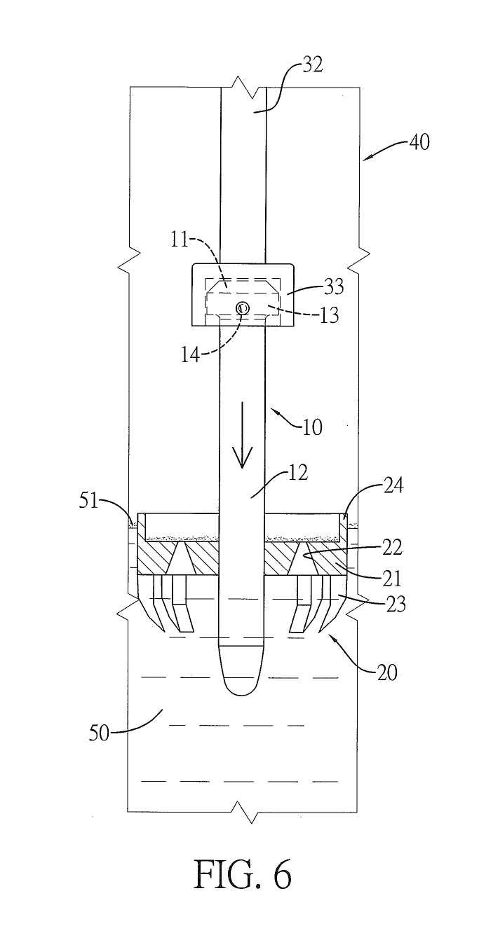

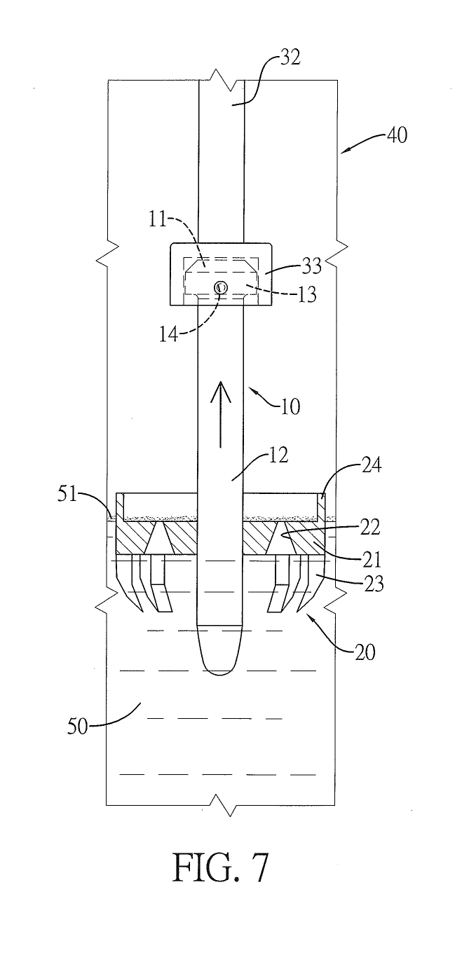

With reference to FIGS. 5 to 7, when the elevatable component 32 descends, the assembling rod 10 is inserted into the VIGA apparatus 40. The assembling rod 10 passes through a slag layer 51 floating above a liquid metal 50 and extends into the liquid metal 50. The deslagging plate 20 mounted to the assembling rod 10 contacts the slag layer 51 first and then descends into the liquid metal 50. Slag of the slag layer 51 flows through the multiple conical channels 22 of the deslagging plate 20 and reaches the first face of the plate 21 of the deslagging plate 20. The slag is surrounded by the blocking wall 24 of the deslagging plate 20. Since each one of the multiple conical channels 22 has the first opening having the diameter smaller than the diameter of the second opening of the conical channel 22, surface tension of the slag layer 51 keeps the slag from flowing from the first opening of each one of the multiple conical channels 22. The blocking wall 24 of the deslagging plate 20 also can block the liquid metal 50 and prevent the liquid metal 50 from flowing across the blocking wall 24 and mixing with the slag again.

Finally, the elevatable component 32 ascends, and the slag of the slag layer 51 is brought up by the deslagging plate 20 to complete deslagging.

The spinning component 33 of the grabbing device 30 spins, the assembling rod 10 mounted to the grabbing device 30 spins together, and the deslagging plate 20 mounted to the assembling rod 10 spins together with the assembling rod 10 and the grabbing device 30. The multiple stirring units 23 of the deslagging plate 20 stir the liquid metal 50 and make the liquid metal 50 distributed evenly.

The multiple conical channels 22 of the deslagging plate 20 allow the slag of the slag layer 51 to pass through and be separated from the liquid metal 50. Each one of the multiple conical channels 22 has the first opening smaller than the second opening to make the slag difficult to flow from the first opening of the conical channel 22 and prevent the slag from mixing with the liquid metal 50.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A deslagging device comprising:
an assembling rod having
a mounting head; and
an assembling section connected to the mounting head; and
a deslagging plate mounted to the assembling rod and having
a plate mounted to the assembling section and having
a first face and a second face facing to opposite directions;
the first face facing to the mounting head;
multiple conical channels defined through the plate and spaced apart from one another; and
each one of the multiple conical channels having
a first opening formed in the first face of the plate and having a diameter; and
a second opening formed in the second face of the plate and having a diameter larger than the diameter of the first opening.

2. The deslagging device as claimed in claim 1, wherein
the plate is a round disk; and
the assembling section is mounted through a center portion of the plate.

3. The deslagging device as claimed in claim 2, wherein the deslagging plate has multiple stirring units formed on the second face of the plate, disposed along a rim of the plate, and circularly disposed around the assembling section.

4. The deslagging device as claimed in claim 1, wherein the multiple conical channels are circularly disposed around the assembling section.

5. The deslagging device as claimed in claim 2, wherein the multiple conical channels are circularly disposed around the assembling section.

6. The deslagging device as claimed in claim 3, wherein the multiple conical channels are circularly disposed around the assembling section.

7. The deslagging device as claimed in claim 1, wherein the mounting head has
a mounting flange; and
a connecting hole defined through the mounting flange along a radial direction that is perpendicular to the assembling rod.

8. The deslagging device as claimed in claim 2, wherein the mounting head has
a mounting flange; and
a connecting hole defined through the mounting flange along a radial direction that is perpendicular to the assembling rod.

9. The deslagging device as claimed in claim 3, wherein the mounting head has
a mounting flange; and
a connecting hole defined through the mounting flange along a radial direction that is perpendicular to the assembling rod.

10. The deslagging device as claimed in claim 4, wherein the mounting head has
a mounting flange; and
a connecting hole defined through the mounting flange along a radial direction that is perpendicular to the assembling rod.

11. The deslagging device as claimed in claim 5, wherein the mounting head has
a mounting flange; and
a connecting hole defined through the mounting flange along a radial direction that is perpendicular to the assembling rod.

12. The deslagging device as claimed in claim 6, wherein the mounting head has
a mounting flange; and
a connecting hole defined through the mounting flange along a radial direction that is perpendicular to the assembling rod.

13. The deslagging device as claimed in claim 1, wherein the deslagging plate has a blocking wall formed on the first face of the plate and circularly extending along a rim of the plate.

14. The deslagging device as claimed in claim 2, wherein the deslagging plate has a blocking wall formed on the first face of the plate and circularly extending along a rim of the plate.

15. The deslagging device as claimed in claim 3, wherein the deslagging plate has a blocking wall formed on the first face of the plate and circularly extending along the rim of the plate.

16. The deslagging device as claimed in claim 4, wherein the deslagging plate has a blocking wall formed on the first face of the plate and circularly extending along a rim of the plate.

17. The deslagging device as claimed in claim 6, wherein the deslagging plate has a blocking wall formed on the first face of the plate and circularly extending along the rim of the plate.

18. The deslagging device as claimed in claim 7, wherein the deslagging plate has a blocking wall formed on the first face of the plate and circularly extending along a rim of the plate.

19. The deslagging device as claimed in claim 9, wherein the deslagging plate has a blocking wall formed on the first face of the plate and circularly extending along the rim of the plate.

20. The deslagging device as claimed in claim 10, wherein the deslagging plate has a blocking wall formed on the first face of the plate and circularly extending along a rim of the plate.
